(19) United States
(12) Patent Application Publication
(10) Pub. No.: US 2018/0302686 A1
(43) Pub. Date: Oct. 18, 2018

(54) PERSONALIZING CLOSED CAPTIONS FOR VIDEO CONTENT

(71) Applicant: International Business Machines Corporation, Armonk, NY (US)

(72) Inventors: Nabarun Bhattacharjee, Kolkata (IN); Tapan Chakrabarti, Kolkata (IN); Sarbajit K. Rakshit, Kolkata (IN); Arindam Sengupta, Kolkata (IN)

(21) Appl. No.: 15/487,467

(22) Filed: Apr. 14, 2017

(51) Int. Cl. H04N 21/488; H04N 21/45; H04N 21/44; H04N 21/442

(52) U.S. Cl. CPC H04N 21/4884; H04N 21/44218; H04N 21/44008; H04N 21/4532

(57) ABSTRACT

In an approach to personalizing closed captioning, one or more computer processors determine a behavior of a plurality of users based on one or more data sources, where the one or more data sources correspond to one or more users of the plurality of users. The one or more computer processors determine one or more closed captioning preferences of the plurality of users based, at least in part, on the determined behavior. The one or more computer processors receive a request from the plurality of users for closed captioning of a video content on a device. The one or more computer processors provide personalized closed captioning on the device for the plurality of users based on the one or more closed captioning preferences.

### BACKGROUND OF THE INVENTION

The present invention relates generally to the field of pictorial communication, and more particularly to personalizing closed captions.

Closed captioning technology has been in use for many years, enabling hearing impaired individuals to understand a spoken dialogue and background sound from movies and television programs. A closed captioning process displays a text summary or transcription occurring for each scene or video image on a portion of the screen. Text placement is a term used to describe the location on the scene where text is displayed. The text can be displayed on any location on the screen, but typically it is displayed at the bottom of the scene. In order to create an illusion of motion, 24 images are displayed subsequently per second. While video is being played, based on the frame rate, the captions can vary in speed. Typically, closed captioning text is not embedded in the main media file but is stored separately. There is a dedicated layer of caption, and, during video playback, the caption is displayed on the video screen from the caption layer.

When an individual views a video content on a screen, the individual may often focus on a particular part of the screen, called an individual's “gaze point”. Eye tracking devices can be utilized to locate the individual's gaze point. The gaze point can indicate a specific area on the video screen that the individual is particularly interested in or engaged by. An eye tracking device can be used in conjunction with video closed captioning to control the speed, size of text displayed during playback. For example, it is possible to slow down the closed captioning text displayed during playback based on an individual's predetermine gaze pattern.

Face recognition is used in biometrics and often as a part of a facial recognition system. A facial recognition system can include, but is not limited to, an optical camera and facial recognition software. Face recognition is also used in video surveillance, human computer interface, and image database management. Face recognition can be regarded as a specific case of object-class detection. In object-class detection, the task is to find the locations and sizes of all objects in an image that belong to a given class; this can include upper torsos, buildings, and cars. Face recognition algorithms focuses on the detection of frontal human faces. It is similar to image detection in which the image of a person is matched bit by bit against an image stored in a database. Any change to the facial feature in the database will invalidate the matching process.

Predictive analytics is an area of data mining that deals with extracting information from data and using the information to predict trends and behavior patterns. Often the unknown event of interest is in the future, but predictive analytics can be applied to any type of unknown, whether it be in the past, present or future. Predictive analytics encompasses a variety of statistical techniques from modeling, machine learning, and data mining that analyze current and historical facts to make predictions about future, or otherwise unknown, events. The core of predictive analytics relies on capturing relationships between explanatory variables and the predicted variables from past occurrences, and exploiting them to predict the unknown outcome.

### SUMMARY

Embodiments of the present invention disclose a method, a computer program product, and a system for personalizing video closed captioning. The method may include one or more computer processors determining a behavior of a plurality of users based on one or more data sources, wherein the one or more data sources correspond to one or more users of the plurality of users. The one or more computer processors determine one or more closed captioning preferences of the plurality of users based, at least in part, on the determined behavior. The one or more computer processors receive a request from the plurality of users for closed captioning of a video content on a device. The one or more computer processors provide personalized closed captioning on the device for the plurality of users based, at least in part, on the one or more closed captioning preferences.

### BRIEF DESCRIPTION OF THE DRAWINGS

FIG. 1 is a functional block diagram illustrating a video closed captioning data processing environment, in accordance with an embodiment of the present invention;

FIG. 2 is a flowchart depicting operational steps of a video closed captioning program, on a server computer within the video closed captioning data processing environment of FIG. 1, for dynamically personalizing closed captioning in videos, in accordance with an embodiment of the present invention; and

FIG. 3 depicts a block diagram of components of the server computer executing the video closed captioning program within the video closed captioning data processing environment of FIG. 1, in accordance with an embodiment of the present invention.

### DETAILED DESCRIPTION

Text displayed by closed captioning can vary in length. Some text can contain longer descriptions or can also be very short, depending on the content of the video. Occasionally, the length of text displayed can be a distraction to someone skilled in the subject matter. For example, a college-level Civil Engineering professor can find it cumbersome to view the full text of a caption on a video about roads and bridges, where the professor is considered an expert. Alternatively, a college freshman trying to learn about astronomy can find it useful to see more substantive text, i.e., content depth, displayed for each frame of a video about the Milky Way galaxy. Furthermore, text reading speed varies from one individual to another individual when viewing a closed captioned video content. For example, the display speed of the subtitle can be too slow for some individuals who are very proficient in the native language. In another example, a multi-lingual individual can have a fast reading speed in their native language but can be slow in their second or third foreign language. Thus, closed captioning may not be customized for an individual whether the individual is a skilled native or an inexperienced non-native speaker. Embodiments of the present invention recognize that improvements to video closed captioning can be made by providing personalized closed captioning, enabling a variety of viewers to watch a video with less distraction based on viewers' preference. Implementation of embodiments of the invention can take a variety of forms, and exemplary implementation details are discussed subsequently with reference to the Figures.

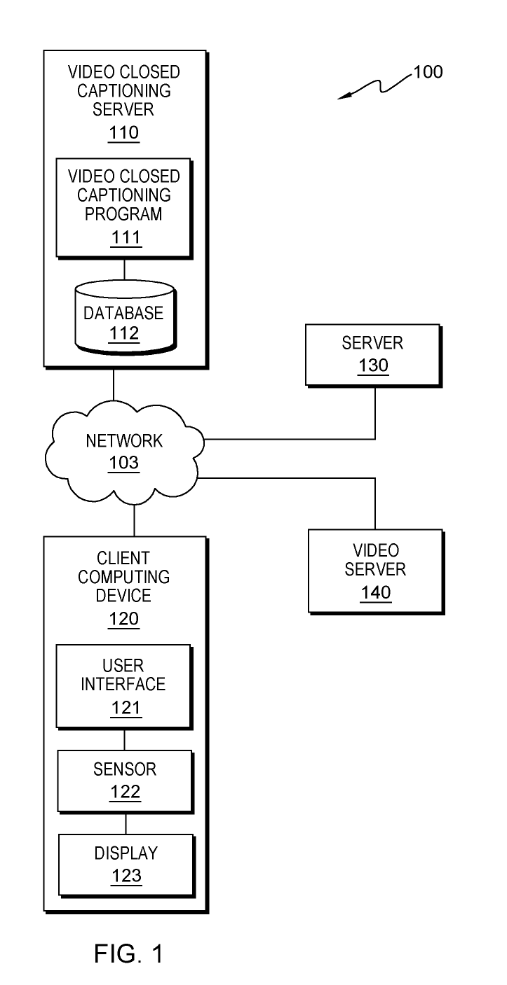

FIG. 1 is a functional block diagram illustrating a video closed captioning data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Video closed captioning data processing environment 100 includes video closed captioning server 110, client computing device 120, server 130, and video server 140, all interconnected over network 103. Network 103 can be, for example, a telecommunications network, a local area network (LAN), a wide area network (WAN), such as the Internet, or a combination of the three, and can include wired, wireless, or fiber optic connections. Network 103 can include one or more wired and/or wireless networks that are capable of receiving and transmitting data, voice, and/or video signals, including multimedia signals that include voice, data, and video information. In general, network 103 can be any combination of connections and protocols that will support communications between video closed captioning server 110, client computing device 120, server 130, video server 140, and other computing devices (not shown) within video closed captioning data processing environment 100.

Video closed captioning server 110 can be a standalone computing device, a management server, a web server, a mobile computing device, or any other electronic device or computing system capable of receiving, sending, and processing data. In other embodiments, video closed captioning server 110 can represent a server computing system utilizing multiple computers as a server system, such as in a cloud computing environment. In another embodiment, video closed captioning server 110 can be a laptop computer, a tablet computer, a netbook computer, a personal computer (PC), a desktop computer, a personal digital assistant (PDA), a smart phone, or any other programmable electronic device capable of communicating with client computing device 120, server 130, video server 140, and other computing devices (not shown) within video closed captioning data processing environment 100 via network 103. In another embodiment, video closed captioning server 110 represents a computing system utilizing clustered computers and components (e.g., database server computers, application server computers, etc.) that act as a single pool of seamless resources when accessed within video closed captioning data processing environment 100. Video closed captioning server 110 includes video closed captioning program 111 and database 112.

Video closed captioning program 111 enables a user experience for viewing videos with subtitles by personalizing closed captioning text for the user. In the depicted embodiment, video closed captioning program 111 resides on video closed captioning server 110. In another embodiment, video closed captioning program 111 can reside on video server 140. Video closed captioning program 111 learns patterns and propensity of the user by aggregating data from a plurality of sources for the user, such as a social media account, an online library account, etc. In an embodiment, after a learning period, video closed captioning program 111 creates a profile of a user. For example, the profile of the user can be based on preferred content length, content depth, and reading speed. Video closed captioning program 111 receives a request from the user to view a video content. After retrieving the profile of the user, video closed captioning program 111 provides a personalized closed captioning layer, based on the profile that accompanies the video media. Video closed captioning program 111 continuously monitors a plurality of parameters from the user, such as physiological changes, gaze pattern, etc. During video playback, video closed captioning program 111 dynamically adjusts the displayed content length, content depth, and display speed based on the changes of the status of the user.

Database 112 is a repository for data used by video closed captioning program 111. In the depicted embodiment, database 112 resides on video closed captioning server 110. In another embodiment, database 112 can reside elsewhere within video closed captioning data processing environment 100, provided that video closed captioning program 111 has access to database. A database is an organized collection of data. Database 112 can be implemented with any type of storage device capable of storing data and configuration files that can be accessed and utilized by video closed captioning server 110, such as a database server, a hard disk drive, or a flash memory. Database 112 uses one or more of a plurality of techniques known in the art to store a plurality of information of a user, such as a preference, a routine, etc. For example, database 112 can store information about a last book read by the user based on posts to an online social media account of the user. In another example, database 112 can store a current education level of the user based on a profile of the user from a job seeker website.

Client computing device 120 can be a laptop computer, a tablet computer, a smart phone, or any programmable electronic mobile device capable of communicating with various components and devices within video closed captioning data processing environment 100, via network 103. Client computing device 120 can be a wearable computer. Wearable computers are miniature electronic devices that can be worn by the bearer under, with, or on top of clothing, as well as in or connected to glasses, hats, or other accessories. Wearable computers are especially useful for applications that require more complex computational support than merely hardware coded logics. In general, client computing device 120 represents any programmable electronic device or combination of programmable electronic devices capable of executing machine readable program instructions and communicating with other computing devices (not shown) within video closed captioning data processing environment 100 via a network, such as network 103. In the present embodiment, client computing device 120 can represent one or more computing devices. In another embodiment, client computing device 120 can include secondary computing devices (not shown) within video closed captioning data processing environment 100. The secondary computing devices can be used in conjunction with client computing device 120. Client computing device 120 includes user interface 121, sensor 122, and display 123.

User interface 121 provides an interface to video closed captioning program 111 on video closed captioning server 110 for a user of client computing device 120. In the depicted embodiment, user interface 121 resides on client computing device 120. In another embodiment, user interface 121 can reside on a secondary computing device (not shown) within video closed captioning data processing environment 100. In one embodiment, user interface 121 can be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 121 can also be mobile application software that provides an interface between client computing device 120 and video closed captioning server 110. Mobile application software, or an “app,” is a computer program designed to run on smart phones, tablet computers, wearable computers and other mobile devices. User interface 121 enables a user to input preferred closed caption preferences such as a language, a reading speed, a topic of interest, etc. For example, if client computing device 120 is a smart phone, then the user can tap a designated button to send a language preference to video closed captioning program 111. In another example, user interface 121 enables the user to interact with video closed captioning program 111, i.e., respond to questionnaires, input a preferred language, etc.

Sensor 122 represents one or more sensors which enable tracking of a user of client computing device 120. In the depicted embodiment, sensor 122 resides on client computing device 120. In another embodiment, sensor 122 resides on a secondary computing device (not shown) within video closed captioning data processing environment 100. A sensor is a device that detects or measures a physical property and then records or otherwise responds to that property, such as vibration, chemicals, radio frequencies, environment, weather, humidity, light, etc. In an embodiment, sensor 122 includes an optical sensor that enables, eye, facial, and head tracking of a user. Generally, eye, facial and head tracking utilize a non-contact, optical method for measuring a body motion and body feature of a user. In another embodiment, sensor 122 can be a video camera or some other specially designed device that senses light. In yet another embodiment, sensor 122 can include eye tracking software that analyzes the reflected light of the eye and compares the changes in reflections and typically use corneal reflection and the center of a pupil as features to track over time. In a further embodiment, sensor 122 can include a facial recognition system that measures distinct features of the face such as the eyes, nose and mouth. In yet another embodiment, sensor 122 can include head tracking software that measures movement of body parts, such as the head. In yet another embodiment, sensor 122 can include devices that detect various frequencies of the electromagnetic radiation spectrum such as near-field communication (NFC) and Bluetooth®. For example, sensor 122 can detect the presence of NFC tags or other NFC enabled devices. In yet another embodiment, sensor 122 can include devices that detect physiological changes such as a heart rate monitor and motion tracker.

Display 123 provides a mechanism to display data to a user and can be, for example, a computer monitor or the lenses of a head mounted display on client computing device 120. Display 123 can also function as a touchscreen, such as a display of a tablet computer or smart phone. Display 123 can also be a television, a video projector, a wearable display, etc. In the depicted embodiment, display 123 resides on client computing device 120. In another embodiment, display 123 resides on a secondary computing device (not shown) within video closed captioning data processing environment 100.

Server 130 and video server 140 can each be a standalone computing device, a management server, a web server, a mobile computing device, or any other electronic device or computing system capable of receiving, sending, and processing data. In another embodiment, server 130 and video server 140 can be a laptop computer, a tablet computer, a netbook computer, a personal computer (PC), a desktop computer, a personal digital assistant (PDA), a smart phone, or any other programmable electronic device capable of communicating with client computing device 120 and other computing devices (not shown) within video closed captioning data processing environment 100 via network 103. In another embodiment, server 130 and video server 140 each represent a computing system utilizing clustered computers and components (e.g., database server computers, application server computers, etc.) that act as a single pool of seamless resources when accessed within video closed captioning data processing environment 100. Server 130 can include one or more of a plurality of platforms for building online social networks among people who share interests, activities, backgrounds, and/or real-life connections. Server 130 can include a plurality of applications such as social network applications and online shopping applications. Social network applications are web-based services that allow individuals to create a public or private profile, to create a list of users with whom to share connections, and to view and interact with the connections within the system. Social network applications can also include communication tools such as mobile connectivity, photo and video sharing, and blogging. Server 130 can include other non-social media based online data sources of the user, including but not limiting to, a library account, a weight loss management program, a favorite television show, a preferred reading speed, a retailer purchase history, etc. Video server 140 streams video media to client computing device 120 via network 103. In one embodiment, video server 140 can include software that analyzes videos and performs auto tagging of the image. In another embodiment, video server 140 can include a video editor that enables tagging of different scenes within a video file where a caption can be displayed.

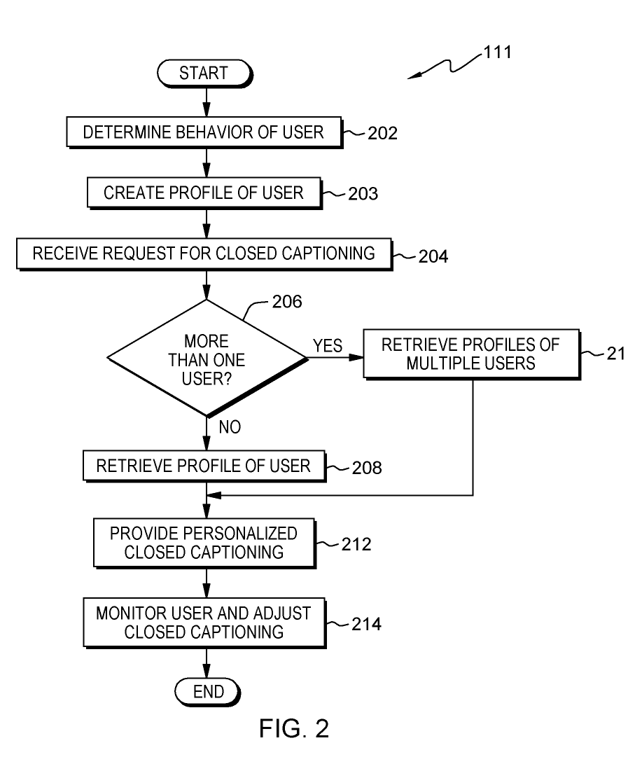

FIG. 2 is a flowchart depicting operational steps of video closed captioning program 111, on video closed captioning server 110 within video closed captioning data processing environment 100 of FIG. 1, in accordance with an embodiment of the present invention.

Video closed captioning program 111 determines a behavior of a user (step 202). Video closed captioning program 111 can use a technique of predictive analytics, such as machine learning, as a method for determining the behavior. A behavior can include, but is not limited to, a habit, a pattern, a routine, a preference, a style, an interest in a topic, a level of interest in a topic, a knowledge level of a topic, a hobby, and a propensity. In an embodiment, video closed captioning program 111 begins a process of learning the behavior of the user by aggregating data from a plurality of sources, such as sources available on server 130. For example, video closed captioning program 111 can learn an education level of the user based on a social media posting, i.e., recognizing the grammatical sentence structure that a college level educated user can typically write. In another example, video closed captioning program 111 can recognize an interest of the user in a particular topic based on the online library account for most frequently rented books. In yet another example, video closed captioning program 111 can recognize a native language of the user, preferred text arrangement, and preferred text directionality based on an online preference setting for a social media account of the user. Text arrangement denotes how a user prefers to view the displayed text sentences and paragraphs. For example, the user can prefer to view text all in one column instead of two columns. Text directionality varies from one language to another. For example, English language is written left to right while Hebrew language is written from right to left. In another embodiment, video closed captioning program 111 can track a reading habit of a user. For example, video closed captioning program 111 can recognize that the user reads the headline of any news content, but when the news topic in the article pertains to sports, the user reads the content in greater detail. In yet another embodiment where client computing device 120 is a tablet reading device, video closed captioning program 111 learns a pattern based on a reading activity of the user. For example, after the user reads an electronic book on the tablet reading device, video closed captioning program 111 stores the title, genre, and reading level of the book in database 112. In a further embodiment, where client computing device 120 is desktop computer which contains a word processing software, video closed captioning program 111 learns a pattern based on a writing activity of the user. For example, if the user is a college student who writes several term papers every month, then video closed captioning program 111 stores the style, language, diction, tone, and voice of the user in database 112.

After aggregating data from a plurality of sources, video closed captioning program 111 analyzes the data to determine a behavior of the user. In an embodiment, video closed captioning program 111 determines the behavior of the user after accumulating a pre-determined amount of data. For example, after retrieving a social media profile setting and an online resume posting of the user, video closed captioning program 111 can determine the behavior of the user and create a baseline dataset. A baseline dataset can include, but is not limited to, a native language, a preferred font size, a preferred text arrangement, an interest in a topic, and a reading speed. In another embodiment, video closed captioning program 111 determines the behavior of a user after a pre-determined amount of time has passed. For example, after observing a user for five days, video closed captioning program 111 can determine the behavior of the user and create the baseline dataset.

Video closed captioning program 111 creates a profile of a user (step 203). Responsive to determining the behavior of the user, video closed captioning program 111 can determine a closed captioning preference of the user to store as a profile. Video closed captioning program 111 can consider several criteria in order to predict a preferred content depth or content length for the user. For example, the content depth can be based on the knowledge of the user regarding the topic. Video closed captioning program 111 stores the preferences as part of the profile of the user in database 112. In one embodiment, video closed captioning program 111 requests an acknowledgement from the user to create a profile. For example, video closed captioning program 111 can send a request via user interface 121 to the user to ascertain whether the user wishes to create a profile based on the learned behavior. If video closed captioning program 111 receives a positive response from the user, then the program creates the profile and stores the information in database 112. In another embodiment, video closed captioning program 111 can receive a preference setting sent from the user via user interface 121. For example, the user can send a preferred language, a preferred font size, and a preferred text speed to video closed captioning program 111 by pressing check boxes labeled, “English language”, “Arial 12”, and “100 WPM” on user interface 121. In yet another embodiment, video closed captioning program 111 can query the user with a series of questions in order to obtain baseline level data for the profile. The baseline data enables video closed captioning program 111 to ascertain basic preferences of the user for viewing the video content. For example, video closed captioning program 111 can query the user to determine the following: a reading speed, a preferred language, a preferred font size, and an interest level. In the embodiment, after receiving responses to the baseline questions, video closed captioning program 111 creates a profile for the user and stores the profile in database 112.

Video closed captioning program 111 receives a request for closed captioning (step 204). In an embodiment, video closed captioning program 111 can receive the request automatically when the user begins to watch a video content via client computing device 120. For example, video closed captioning program 111 can automatically receive a notification that the user requested a video as soon as the user begins to stream video from an online media content provider via client computing device 120. In another embodiment, video closed captioning program 111 can automatically receive a request from the user via sensor 122. For example, where sensor 122 is an optical camera, the sensor recognizes the user via facial recognition software as the user approaches display 123 and sends a request to video closed captioning program 111. In another example, video closed captioning program 111 can receive a request from client computing device 120 via a Bluetooth® signal. For example, a secondary computing device can be a wearable computer that emits a Bluetooth® signal, automatically signaling video closed captioning program 111 to begin as the user approaches display 123. In yet another embodiment, video closed captioning program 111 receives a request from client computing device 120 via user interface 121. For example, video closed captioning program 111 receives a request after the user presses a designated button on user interface 121.

Video closed captioning program 111 determines whether there is more than one user watching the video (decision block 206). In order to provide a personalized experience for the user, video closed captioning program 111 ascertains the number of users present. In one embodiment, video closed captioning program 111 can detect the presence of multiple mobile devices via sensor 122. For example, where sensor 122 is a radio frequency detection device, sensor 122 can determine the number of users by detecting the presence of Bluetooth® or NFC signals. In another embodiment, video closed captioning program 111 detects the number of users via sensor 122. For example, where sensor 122 is a camera with facial recognition software, the sensor begins scanning the surrounding area of client computing device 120 to determine the number and identity of the users and relays the information to video closed captioning program 111.

If video closed captioning program 111 determines that there is only one user (“no” branch, decision block 206), then the program retrieves the profile of the user (step 208). Video closed captioning program 111 retrieves the profile of the user from database 112. In an embodiment, if the profile of the user does not exist, then video closed captioning program 111 can query the user with a series of questions in order to obtain baseline level data. The baseline data will help video closed captioning program 111 ascertain basic preferences of the user for viewing the video content as discussed with respect to step 203. For example, video closed captioning program 111 can query the user a series of questions to determine the following: a reading speed, a preferred language, a preferred font size, and an interest level. In the embodiment, after receiving responses to the baseline questions, video closed captioning program 111 creates a profile for the user and stores the profile in database 112.

If video closed captioning program 111 determines that there are multiple users (“yes” branch, decision block 206), then the program retrieves profiles of the multiple users (step 210). In an embodiment, video closed captioning program 111 retrieves the profiles of individual users of a group from database 112. In another embodiment, video closed captioning program 111 retrieves the profile of an owner of client computing device 120. Video closed captioning program 111 designates the profile of the owner of client computing device 120 as a default master profile for the system. The default master profile overrides other preferences of other users who are using client computing device 120 belonging to the owner. For example, video closed captioning program 111 retrieves the profiles of individual users who are viewing video on client computing device 120 via display 123 and ranks the profiles according to a user selected hierarchy setting. The hierarchy setting can include, but is not limited to, youngest user to oldest user, lowest language proficiency of a user to the highest language proficiency of a user, and lowest education level of a user to highest education level of a user. After ranking the profiles, video closed captioning program 111 sets the preference according to the hierarchy. If video closed captioning program 111 does not find any hierarchy setting, then the program may use the profile of the owner of client computing device 120 as the default preference for the group. In a further embodiment, users with existing profiles can override the default profile of the owner of client computing device 120. For example, after video closed captioning program 111 retrieves the profiles of the individual users of the group, a single user of the group who is not the owner of client computing device 120 can pick a different profile or create a new profile for the group instead of the default profile via user interface 121.

In another embodiment, if the profiles of any individual users of the group do not exist, then video closed captioning program 111 can query each individual user of the group without an individual profile with a series of questions in order to obtain a baseline level dataset for the group viewing the video content. In order to determine the baseline level for each individual user, video closed captioning program 111 can query each user for a dataset. For example, the dataset can include, but is not limited to, a reading speed, a preferred font size, a common language, and an interest level. In another embodiment, video closed captioning program 111 transmits a series of questions to client computing device 120 and other computing devices (not shown) within video closed captioning data processing environment 100 and receives individual responses from the users. In a further embodiment, video closed captioning program 111 can create individual profiles of the users from the group if the individual profiles do not exist. For example, some group members may already have a profile and some may not. Video closed captioning program 111 can store multiple profiles of individual users in database 112. After receiving and aggregating individual responses to the baseline questions, video closed captioning program 111 can ascertain the preference of the group.

In an embodiment, video closed captioning program 111 retrieves a group profile from database 112. In another embodiment, if the group profile does not exist, then video closed captioning program 111 can query the group a series of questions in order to understand the preference of the group such as a common language, an interest level, a preferred font size, and a reading speed. For example, video closed captioning program 111 transmits a series of questions to display 123 and receives a group response via one user inputting to client computing device 120 via user interface 121. In another example, video closed captioning program 111 can receive multiple responses to the questions from one user inputting on client computing device 120 and other users inputting on other computing devices within video closed captioning data processing environment 100 (not shown). After receiving responses from the users, video closed captioning program 111 can aggregate the responses and determine the common language, a preferred font size, an aggregated content speed, and an aggregated depth of content for the group. In a further embodiment, video closed captioning program 111 can create a profile for the group after aggregating responses from the users. Video closed captioning program 111 can store the profile of the group in database 112.

Video closed captioning program 111 provides personalized closed captioning (step 212). In an embodiment where there is a group watching a video and a group profile exists, video closed captioning program 111 can provide personalized closed captioning for the group by adjusting a plurality of parameters, such as preferred font size, text placement, content depth, content length, and speed of text based on the preferences stored in the group profile. For example, after retrieving the group profile, video closed captioning program 111 can provide personalized closed captioning for the group of users based on the preferences in the profile. In another example, after retrieving the group profile, if video closed captioning program 111 determines the preferred language of the group is the same as the video, then the program can decrease content length of the closed captioning text. In yet another example, video closed captioning program 111 can adjust the content depth, i.e., add more text content, based on the aggregated group interest in watching a documentary. In another embodiment, after retrieving the group profile, video closed captioning program 111 can determine that the group includes a member with special needs. For example, video closed captioning program 111 can increase the font size of the caption to accommodate a visually impaired individual.

In an embodiment where there is a group watching a video and the profiles of the individual users exist, video closed captioning program 111 can provide personalized closed captioning for the group by adjusting a plurality of parameters, such as preferred font size, text placement, content depth, content length, and speed of text based on the preferences stored in the profiles of the individual users. For example, after retrieving one or more profiles of the users, video closed captioning program 111 can provide personalized closed captioning for the one or more users based on the preferences in the profile of the one or more users.

In an embodiment where the viewer is a single user, video closed captioning program 111 can provide personalized closed captioning for the single user by adjusting a plurality of parameters. For example, after retrieving the profile of the user, video closed captioning program 111 can adjust a plurality of parameters such as preferred font size, text placement, content depth, content length, and speed of text based on the preference of the single user. In another example, if video closed captioning program 111 determines that the user does not have the same knowledge level as the current topic of the video, then the video closed captioning program can add more informative content to the video caption, i.e., content depth. In a further example, after retrieving the user profile, if video closed captioning program 111 determines both the preferred language of the user and the video content are in English, then the program can shorten the text of the caption. In yet another example, video closed captioning program 111 can speed up the text and shorten the length of the caption after ascertaining the user has authoritative knowledge of the video topic.

Video closed captioning program 111 monitors the user and adjusts closed captioning (step 214). In an embodiment, while the user is watching the video, video closed captioning program 111 can continuously monitor the user and dynamically adjust the closed captioning to correspond with a change in status of the user. In one embodiment, where sensor 122 is an eye tracking device, video closed captioning program 111 can receive data from the sensor that can indicate that the user is unable to complete reading the text for each scene. For example, the eye tracking device can detect a change in gaze point of the user to determine if the user is able to read the entire text caption of each scene. If user is not able to finish reading the entire text for each scene, then video closed captioning program 111 can pause the scene to allow the user to catch up reading. In another embodiment, where sensor 122 is a wearable heart rate monitoring device, video closed captioning program 111 can identify a change in mood of the user by detecting a change in a heartbeat of a user. If the heartbeat of the user rises, which can suggest that the user is in a state of heightened awareness, i.e., frightened, then video closed captioning program 111 can decrease the speed of text or pause the closed captioning text to enable the user to catch up reading. In addition, if the user is unable to catch up reading the text, then video closed captioning program 111 can send the closed captioning text to a secondary device of a user. In one embodiment, the user can request video closed captioning program 111 to send the closed captioning text to the secondary device of the user. For example, video closed captioning program 111 can receive a request from client computing device 120 by the user pressing a displayed command button labeled “Continue closed captioning on another device” on user interface 121. In another embodiment where sensor 122 is an eye tracking device, the sensor can detect a pupil size of the user to determine the interest level of the user during video viewing. Sensor 122 can send data regarding the pupil size of the user to video closed captioning program 111, and the video closed captioning program can change the depth and length of content of the closed captioning program to match the interest level of the user. For example, video closed captioning program 111 can increase the depth and length of content when the user exhibits an interested state via pupil dilation. In yet another embodiment where sensor 122 is an eye tracking device, the sensor can detect a gaze point of a user to determine eyesight acuity of the user during video viewing. Sensor 122 can send data regarding the gaze point of the user to video closed captioning program 111, and the program can change the font size to match the eyesight power of the user.

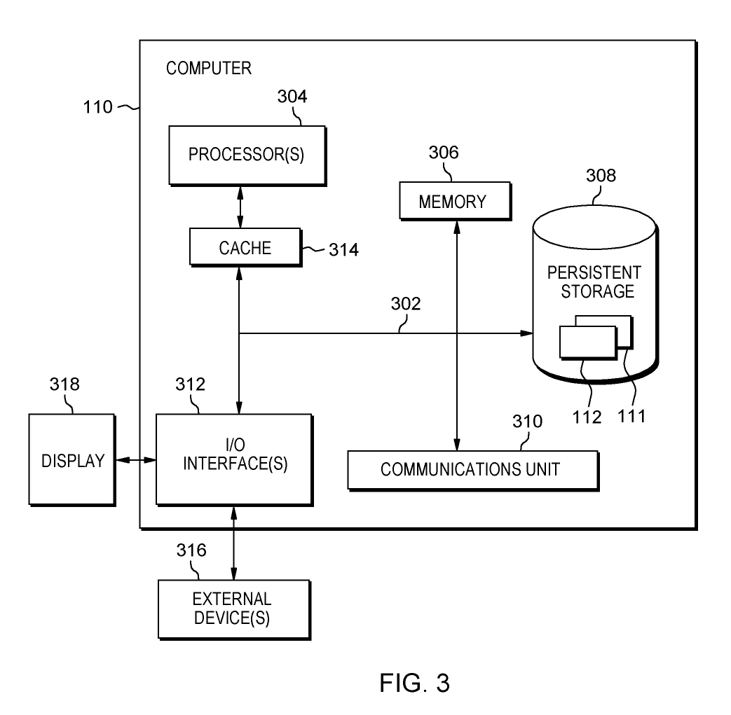

FIG. 3 depicts a block diagram of components of video closed captioning server 110 within video closed captioning data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Video closed captioning server 110 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., video closed captioning program 111 and database 112, can be stored in persistent storage 308 for execution and/or access by one or more of the respective processor(s) 304 of video closed captioning server 110 via memory 306. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 120, server 130, and video server 140. In these examples, communications unit 310 includes one or more network interface cards. Communications unit 310 may provide communications through the use of either or both physical and wireless communications links. Video closed captioning program 111 and database 112 may be downloaded to persistent storage 308 of video closed captioning server 110 through communications unit 310.

I/O interface(s) 312 allows for input and output of data with other devices that may be connected to video closed captioning server 110. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., video closed captioning program 111 and database 112 on video closed captioning server 110, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor or the lenses of a head mounted display. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for personalizing video closed captioning, the method comprising the steps of:
determining, by one or more computer processors, a behavior of a plurality of users associated with one or more data sources based on machine learning technique, wherein the one or more data sources correspond to one or more users of the plurality of users;
determining, by one or more computer processors, one or more closed captioning preferences of the plurality of users based, at least in part, on the determined behavior;
receiving, by the one or more computer processors, a request from the plurality of users for closed captioning of a video content on a device;
providing, by one or more computer processors, personalized closed captioning on the device for the plurality of users based, at least in part, on the one or more closed captioning preferences;
monitoring, by one or more computer processors, for a change in status of one or more parameters of the one or more users of the plurality of users during viewing of the video content, wherein the one or more parameters include at least a physiological change; and
adjusting, by one or more computer processors, the closed captioning corresponding to the change in status of the one or more parameters of the one or more users.

2. The method of claim 1, further comprising the steps of:
creating, by one or more computer processors, a profile of the plurality of users, wherein the profile includes the one or more closed captioning preferences of the plurality of users; and
retrieving, by the one or more computer processors, the profile of the plurality of users.

3. (canceled)

4. The method of claim 1, wherein monitoring for a change in status of the one or more parameters of the one or more users of the plurality of users during viewing of the video content further comprises receiving, by the one or more computer processors, data from a sensor, wherein the data includes at least one of a gaze pattern, a heartbeat, and a pupil size.

5. The method of claim 1, wherein determining a behavior of the plurality of users based on one or more data sources further comprises:
aggregating, by the one or more computer processors, data from the one or more data sources, wherein the data corresponds to one or more closed captioning preferences of the plurality of users;
analyzing, by the one or more computer processors, the aggregated data; and
creating, by the one or more computer processors, a baseline dataset based, at least in part, on the aggregated data.

6. The method of claim 1, wherein the one or more closed captioning preferences include at least one of: a language, a reading speed, a topic of interest, a font size, a text placement, a content depth, and a content length.

7. The method of claim 1, wherein the one or more data sources include at least one of: a social media account, an online library account, an online reading activity, a writing activity, an online shopping application, an online resume posting, an online media content provider, a weight loss management program, a television show, a preferred reading speed, and a retailer purchase history.

8. The method of claim 1, wherein the behavior includes at least one of: a habit, a pattern, a routine, a preference, a style, an interest in a topic, a level of interest in a topic, a knowledge level of a topic, a hobby, and a propensity.

9. A computer program product for personalizing video closed captioning, the computer program product comprising:
one or more computer readable storage devices and program instructions stored on the one or more computer readable storage devices, the stored program instructions comprising:
program instructions to determine a behavior of a plurality of users associated with one or more data sources based on machine learning technique, wherein the one or more data sources correspond to one or more users of the plurality of users;
program instructions to determine one or more closed captioning preferences of the plurality of users based, at least in part, on the determined behavior;
program instructions to receive a request from the plurality of users for closed captioning of a video content on a device;
program instructions to provide personalized closed captioning on the device for the plurality of users based, at least in part, on the one or more closed captioning preferences;
program instructions to monitor for a change in status of one or more parameters of the one or more users of the plurality of users during viewing of the video content, wherein the one or more parameters include at least a physiological change; and
program instructions to adjust the closed captioning corresponding to the change in status of the one or more parameters of the one or more users.

10. The computer program product of claim 9, the stored program instructions further comprising:
program instructions to create a profile of the plurality of users, wherein the profile includes the one or more closed captioning preferences of the plurality of users; and
program instructions to retrieve the profile of the plurality of users.

11. The computer program product of claim 9, wherein the program instructions to determine a behavior of the plurality of users based on one or more data sources comprise:
program instructions to aggregate data from the one or more data sources, wherein the data corresponds to one or more closed captioning preferences of the plurality of users;
program instructions to analyze the aggregated data; and
program instructions to create a baseline dataset based, at least in part, on the aggregated data.

12. The computer program product of claim 9, wherein the one or more closed captioning preferences include at least one of: a language, a reading speed, a topic of interest, a font size, a text placement, a content depth, and a content length.

13. The computer program product of claim 9, wherein the one or more data sources include at least one of: a social media account, an online library account, an online reading activity, a writing activity, an online shopping application, an online resume posting, an online media content provider, a weight loss management program, a television show, a preferred reading speed, and a retailer purchase history.

14. The computer program product of claim 9, wherein the behavior include at least one of: a habit, a pattern, a routine, a preference, a style, an interest in a topic, a level of interest in a topic, a knowledge level of a topic, a hobby, and a propensity.

15. A computer system for personalizing video closed captioning, the computer system comprising:
one or more computer processors;
one or more computer readable storage devices;
program instructions stored on the one or more computer readable storage devices for execution by at least one of the one or more computer processors, the stored program instructions comprising:
program instructions to determine a behavior of a plurality of users associated with one or more data sources based on machine learning technique, wherein the one or more data sources correspond to one or more users of the plurality of users;
program instructions to determine one or more closed captioning preferences of the plurality of users based, at least in part, on the determined behavior;
program instructions to receive a request from the plurality of users for closed captioning of a video content on a device; and
program instructions to provide personalized closed captioning on the device for the plurality of users based, at least in part, on the one or more closed captioning preferences;
program instructions to monitor for a change in status of one or more parameters of the one or more users of the plurality of users during viewing of the video content, wherein the one or more parameters include at least a physiological change; and
program instructions to adjust the closed captioning corresponding to the change in status of the one or more parameters of the one or more users.

16. The computer system of claim 15, the stored program instructions further comprising:
program instructions to create a profile of the plurality of users, wherein the profile includes the one or more closed captioning preferences of the plurality of users; and
program instructions to retrieve the profile of the plurality of users.

17. The computer system of claim 15, wherein the program instructions to determine a behavior of the plurality of users based on one or more data sources comprise:
program instructions to aggregate data from the one or more data sources, wherein the data corresponds to one or more closed captioning preferences of the plurality of users;
program instructions to analyze the aggregated data; and
program instructions to create a baseline dataset based, at least in part, on the aggregated data.

18. The computer system of claim 15, wherein the one or more closed captioning preferences include at least one of: a language, a reading speed, a topic of interest, a font size, a text placement, a content depth, and a content length.

19. The computer system of claim 15, wherein the one or more data sources include at least one of: a social media account, an online library account, an online reading activity, a writing activity, an online shopping application, an online resume posting, an online media content provider, a weight loss management program, a television show, a preferred reading speed, and a retailer purchase history.

20. The computer system of claim 15, wherein the behavior include at least one of: a habit, a pattern, a routine, a preference, a style, an interest in a topic, a level of interest in a topic, a knowledge level of a topic, a hobby, and a propensity.
